(19) United States
(12) Patent Application Publication
(10) Pub. No.: US 2003/0114135 A1
(43) Pub. Date: Jun. 19, 2003

(54) WIRELESS PHONE LINK

(76) Inventor: JEFFREY LORBECK, SAN DIEGO, CA (US)

Correspondence Address: Qualcomm Incorporated, Patents Department, 5775 Morehouse Drive, San Diego, CA, 92121-1714, US

(21) Appl. No.: 09/386,866

(22) Filed: Aug. 31, 1999

(51) Int. Cl. H04H 1/00

(52) U.S. Cl. 455/403; 455/465; 455/3.05

(57) ABSTRACT

A fixed phone arrangement for a satellite communications system is disclosed. A radio antenna unit is mounted in a location to provide optimum line of sight communication with one or more satellites so as to provide a wireless link to a central station over a first wireless link. A terminal unit is located in any convenient place that enables it to communicate with the radio antenna unit over a second wireless link, preferably using CT-1 frequencies.

### BACKGROUND OF THE INVENTION

I. Field of the Invention

The present invention relates generally to the field of wireless telephone links, and more specifically, to wireless cellular frequency, radio frequency and satellite frequency links. Still more specifically, the invention relates to a satellite fixed phone system having a wireless connection between a radio antenna unit and a phone handset unit.

II. Description of the Related Art

Telephone service is widespread in most developed areas and countries so that it is possible to communicate telephonically nearly worldwide. However, even today, many remote areas, especially in underdeveloped, third world countries, lack wireline or terrestrial cellular telephone service. The infrastructure necessary to provide wireline or terrestrial cellular service to remote areas of underdeveloped or developing countries is often very costly, and not cost effective in view of the small number of people that would be served by such services. Even in the United States, which is considered technologically sophisticated with respect to cellular telecommunications, cellular services are available on only 30-40 percent of the United States land mass. In remote areas of the world, cellular services are much less common. Two-way communications in these remote areas of underdeveloped or developing countries are either non-existent or are limited to old-style HAM radio transmissions, which are often unreliable and require an operator to be standing by at the other end of the communication link. Because standard telecommunications facilities are lacking in these areas, it is an extremely expensive and arduous task to place a simple voice telephone call.

The advent of satellite communications system has made it possible to provide telephone service to even the most remote locations in much of the world. Commercial satellite systems are being established that will provide coverage to 70%-80% or better of the earth's surface. From the user's standpoint, satellite phones will operate in much the same manner as conventional wired or cellular phones. One significant advantage satellite phone systems have over either wired or cellular phone systems is the need for much less infrastructure. Wired phones require that wires be strung along rights of way between central offices and homes or businesses. Cellular systems require that many antenna sites and base stations be established due to the fact that the communications range of cellular signals is relative small, generally only a few miles. Cellular systems do not operate well in geographically difficult areas, such as mountainous regions, where line of sight communication is difficult. Neither wired nor cellular systems operate in the middle of oceans. Satellite phone systems require only a relatively few base stations or gateways; and these can be located thousands of miles apart from each other.

Wireless telephones, which include both satellite and cellular phones, are communications devices that function in a wireless environment. There are three basic types of wireless telephones. Portable phones are typically small, handheld devices that can be carried on the person. Mobile phones are typically mounted in a vehicle; they have a base unit or cradle that is fixedly mounted to the vehicle, usually inside the passenger compartment, and a handset that is connected to the base unit or cradle by a wire. A fixed wireless phone is usually mounted in a single location. Any of these types of phones can be operated over a terrestrial cellular network or over a satellite communications network. Some wireless phones are capable of operating over both cellular and satellite systems.

Wired phones are those connected directly to a wireline phone system by wires. Wired phones are the typical standard phones found in what is called POTS (Plain Old Telephone Systems). Telephones that operate over short range wireless links, such as portable phones that are used in the home or small business environment, and which transmit to and receive signals from a single fixed base station or unit over a short range (for example, several hundred to a thousand meters), where the base unit is directly connected to a wireline communications network, are not considered wireless phones for purposes of this disclosure. Such single station, short range wireless phones are called “cordless phones” and are considered to fall in the category of standard wireline phones (that is, phones connected to the communications network by wires).

Where wired or cellular voice facilities are lacking, a number of creative solutions have been employed to provide telephone service. As an example, in some underdeveloped regions, a terrestrial tower is commonly established as a base station, permitting a wireless local loop (WLL) between the telephones serviced in a local area.

Another proposed solution under current development is the use of a satellite telephone system. In a satellite phone system, a radio antenna unit (RAU) is used in combination with a telephone handset. The RAU, which can be designed to receive radio frequency signals from a satellite, is connected by a very thick cable to a telephone handset. Satellites communicating with the RAU can be geosynchronous earth orbit (GEO) satellites or alternatively non-geosynchronous satellites, such as medium earth orbit (MEO) or low earth orbit (LEO) satellites. Satellite communication frequency signals are transmitted to and received from a fixed user terminal (for example, a wall or desk mounted terminal unit) to and from a satellite via a transceiver located in the RAU.

An RAU communicating with satellites includes a power amplifier (PA), a low-noise amplifier (LNA), and an antenna. The RAU is connected to the terminal incorporating a telephone handset by a thick cable. The PA amplifies signals received from the telephone handset and transmits the amplified signals to the antenna. The LNA amplifies signals received from the antenna, and transmits the amplified signals to the telephone handset over the cable.

There are certain disadvantages of currently proposed fixed wireless phone systems for remote location use. One principal disadvantage is cost. The typical fixed wireless phone system comprising an RAU, a terminal and the associated connecting cable is often too expensive for a rural village to purchase. Additionally, the physical arrangement of the structure is limited by the length of the cable required to connect the RAU and the terminal unit. Degradation of the signal (called “signal loss”) between the RAU and the telephone handset over the cable is quite prevalent. A very thick coaxial cable, having a bend radius of approximately one meter, must be used to reduce signal losses. Even with an extremely high-grade coaxial cable, such as LMR-100, recognized for its low loss characteristics, the cable length must be limited to no more than 25 to 40 feet. This will often limit optimal placement of the RAU for good satellite communication in relation to the desired location of the terminal (for example, in a central location in a village). In addition, such high-grade coaxial cables are quite expensive, especially for individuals or small villages in remote areas.

What is required is a system and method for providing low cost and cost effective telephone communications facilities and services to remote areas.

### SUMMARY OF THE INVENTION

The present invention comprises a fixed phone arrangement for a satellite communications system. A radio antenna unit is mounted in a location to provide optimum line of sight communication with one or more satellites, or other desired signal sources, so as to provide a wireless link to a central station over a first wireless link. A terminal unit is located in any convenient place that enables it to communicate with the radio antenna unit over a second wireless link, preferably using CT-1 type frequencies.

### BRIEF DESCRIPTION OF THE DRAWINGS

The present invention will be described with reference to the accompanying drawings. In the drawings, like reference numbers generally indicate identical, functionally similar, and/or structurally similar elements. The drawing in which an element first appears is indicated by the leftmost digit(s) in the reference number.

FIG. 1 illustrates an exemplary fixed phone facility and low earth orbit satellite communications environment;

FIG. 2 is a block diagram illustrating the communications between a radio antenna unit and a gateway in greater detail;

FIG. 3 is an exemplary block diagram of a radio antenna unit;

FIG. 4 is an exemplary block diagram of a fixed phone;

FIG. 5 illustrates an exemplary cordless telephone;

FIG. 6 illustrates an exemplary fixed phone satellite communications setup using a cable connection between the radio antenna unit and the terminal unit; and

FIG. 7 illustrates an exemplary fixed phone satellite communications setup modified in accordance with the present invention.

### DETAILED DESCRIPTION OF THE PREFERRED EMBODIMENTS

The present invention is described in terms of an example environment of a satellite communications system. Such systems are described in U.S. Pat. No. 4,901,307, issued Feb. 13, 1990, entitled “Spread Spectrum Multiple Access Communication System Using Satellite or Terrestrial Repeaters,” U.S. Pat. No. 5,691,974, which issued Nov. 25, 1997, entitled “Method and Apparatus for Using Full Spectrum Transmitted Power in a Spread Spectrum Communication System for Tracking Individual Recipient Phase Time and Energy;” and U.S. patent application Ser. No. 09/120, 859 filed Jul. 21, 1998, entitled “System And Method For Reducing Call Dropping Rates In A Multi-Beam Communication System,” all of which are commonly assigned with the present invention; and the disclosures of which are incorporated herein by reference. These patents, by way of example, utilize CDMA spread spectrum communication techniques which proved some advantages. However, the present invention is not limited to such modulation techniques or environment.

In this example environment, a fixed phone facility includes a radio antenna unit (RAU) mounted on a tower or other elevated object in a rural or remote location with no wired telephone infrastructure. A terminal unit or phone is associated with the RAU. The phone communicates, via the RAU, a low earth orbit (LEO) satellite, and a gateway, with other terminal units in a known manner, as described, for example in the above-mentioned patents, and in U.S. patent application Ser. No. 09/201,701, entitled “Control Interface Protocol For Telephone Sets For A Satellite Telephone System”; Ser. No. 09/201,700, entitled “Audio Interface For Satellite User Terminals”; Ser. No. 09/201,520, entitled “Ringer for Satellite User Terminals,” Ser. No. 09/201,577, entitled “Apparatus And Method For Address Assignments For Satellite Telephone,” which were all filed Nov. 30, 1998, and are incorporated herein by reference.

Description in these terms is provided for convenience only. It is not intended that the invention be limited to application in this example environment. For example, the terminal and RAU can be incorporated into a terrestrial cellular communications system. After reading the following description, it will become apparent to a person skilled in the relevant art how to implement the invention in alternative environments. In fact, it will be clear that the present invention can be utilized in many types of communications systems.

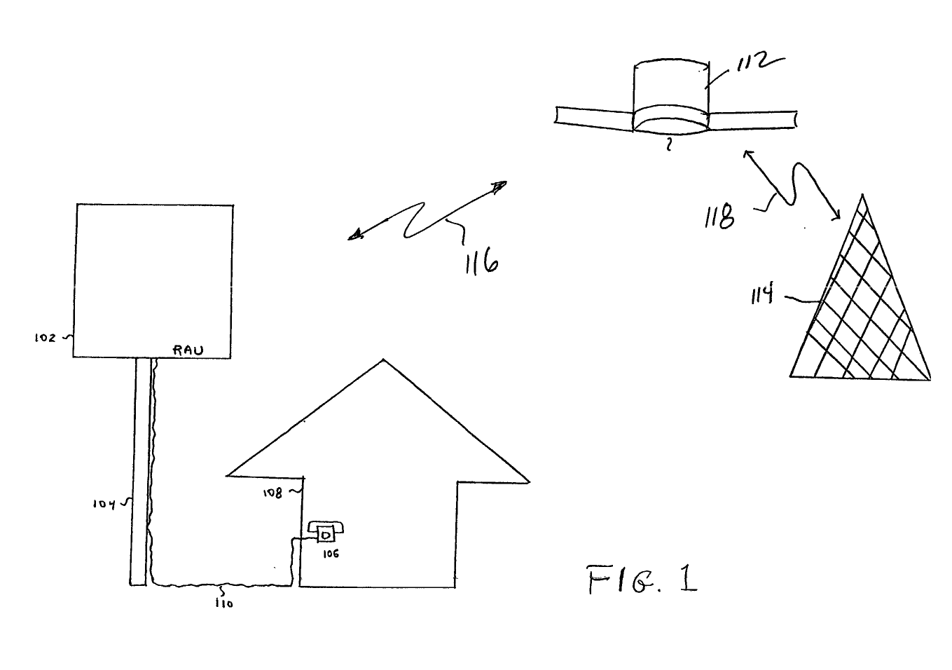

FIG. 1 illustrates a known example of a LEO satellite communications environment incorporating a fixed phone facility. Sometimes called a “village phone,” because it may be the only phone in a village or remote community, the fixed phone facility is intended to provide telephone services for users in remote or desolate areas, where a wired telephone system infrastructure, such as a public switched telephone network (PSTN), is lacking.

FIG. 1 comprises an RAU 102 located on a tower (or pole) 104, and a terminal unit 106 located in a dwelling 108. However a variety of structures or physical objects including various buildings, trees, and so forth, can be use to support RAU 102, and a variety of buildings or structures, including temporary ones, can be used to house terminal unit 108, depending on the specific applications.

Terminal unit 106 typically appears similar to a standard desk or wall-mounted telephone with a base unit containing a keypad for dialing and a handset connected to the base unit by wires and containing a microphone and speaker. In known contemplated systems, a cable 110 connects RAU 102 with terminal unit 106. The communications system further includes at least one LEO satellite 112, and at least one gateway 114. A radio communications link 116 links RAU 102 with satellite 112. Another radio communications link 118 links satellite 112 with gateway 114.

In one embodiment, LEO satellite 112 is one of 48 LEO satellites in a 1414 kilometer low earth orbit. The 48 satellites are respectively distributed in 8 orbital planes, with six equally-spaced satellites in each orbital plane. (This is referred to as a Walker constellation.) Each satellite completes an orbit every 114 minutes, with the orbital planes inclined 52° with respect to the equator. Each satellite 112 may communicate with two or more gateways 114 at the same time. Similarly, each RAU 102 may be able to “see” and communicate with two or more satellites 112 at the same time. Thus, satellites 112 and gateways 114 are not unique to a given RAU 102.

The Walker constellation provides two or more satellites in view of a communications device between about 70° south latitude and about 70° north latitude. This constellation coverage will permit a user, using a satellite communications device, to communicate with another user at nearly any point on the surface of the earth within a gateway coverage area. Since gateway 114 can connect to a PSTN, virtually any two users can communicate via the satellites. It is also possible that gateway 114 can be used to connect to non-PSTN facilities and telephone equipment.

In the disclosed embodiment, a caller using terminal unit 106 communicates with other callers using satellite communications, LEO satellites and gateways in a LEO satellite system. However, as noted, those skilled in the art will recognize that other communications media and facilities can be used as well, such as cellular radio frequency communications via base stations, or other types of satellite communications.

In one embodiment, satellite 112 effectively functions as a “bent pipe” repeater. Satellite 112 receives a communications traffic signal, such as a voice signal or a data signal, from either a communications device, such as RAU 102, or from gateway 114. Each satellite 112 then converts the received communications traffic signal to another frequency band and retransmits the converted signal to gateway 114. Gateway 114 directs the communication signal to the ultimate destination terminal or user.

In the exemplary embodiment, satellite 112 has only the aforementioned bent pipe function, and provides no further processing, such as signal processing of received communications traffic, or providing awareness of the messages actually being transmitted. However, it should be noted that the bent pipe functions of satellite 112 are only exemplary of LEO satellites, and are not limiting to the present invention. In this example embodiment, there is no direct communications link between any two satellites. Thus, each satellite 112 functions as a bent pipe between communications devices and gateways.

Communications devices that communicate with satellite 112 includes a wide array of devices. For example, the communications devices can be fixed telephones, paging/messaging devices, facsimile machines or computer modems. In one embodiment, RAU 102 has an omnidirectional antenna providing bidirectional communications via one or more satellites, as for example satellite 112. To reduce interference, RAU 102 can also have a directional or higher gain antenna, such as a parabolic shaped dish antenna.

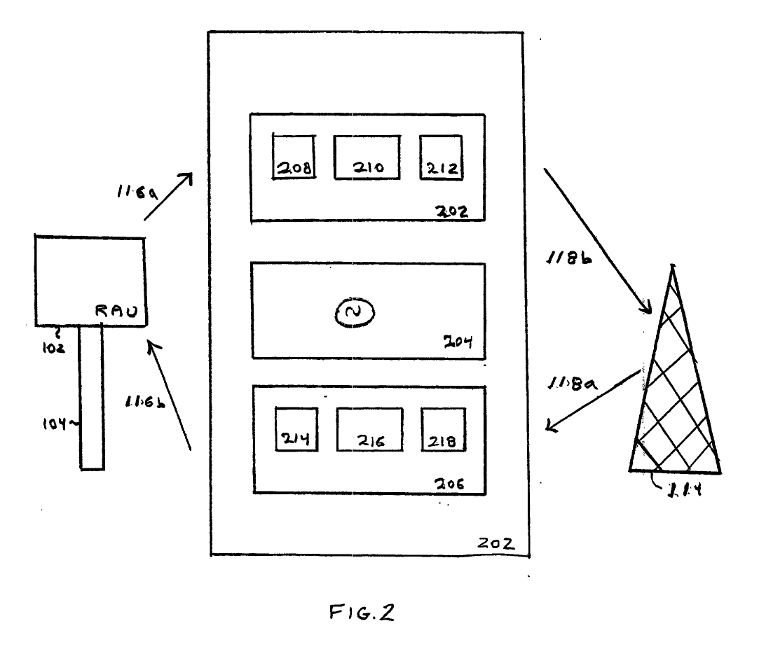

FIG. 2 is a block diagram illustrating the communications between RAU 102 and gateway 114 in greater detail. Satellite 112 comprises a return transponder 202, a master frequency generator 204, and a forward transponder 206. Return transponder 202 comprises L band antenna 208, L-C band frequency conversion section 210, and satellite feeder link antenna 212. Forward transponder 206 comprises S band antenna 214, C-S frequency conversion section 216 and satellite feeder link antenna 218.

Communications link 116, between RAU 102 and satellite 112, comprises an up link 116a from RAU 102 to satellite 112, and a down link 116b from satellite 112 to RAU 102. Similarly, communications link 118, between gateway 114 and satellite 112, comprises an up link 118a from gateway 114 to satellite 112, and a down link 118b from satellite 112 to gateway 114.

In a preferred embodiment, RAU 102 and terminal unit 106 have the capacity to operate in full duplex mode. Communications link 116a (the up link to satellite 112) is an L band RF link operating within a frequency range of 1.61 GHz to 1.625 GHz. Communications link 116b (the down link from satellite 112) is an S band RF link operating in the frequency range of 2.485 GHz to 2.5 GHz. Information conveyed over communications link 116a is received at L band antenna 208, and converted to a C band signal by way of frequency conversion section 210. The converted information is transmitted to satellite feeder link antenna 212, which transmits the resulting C band signal down to gateway 114 over communications link 118b (the down link to gateway 114).

Similarly, in a preferred embodiment, information from gateway 114 is transmitted over communications link 118a (the up link from gateway 114) to satellite feeder link antenna 218. Satellite feeder link antenna 218 transmits the C band signal to C-S band frequency conversion section 216. C-S band frequency conversion section 216 converts the frequency of the received signal to the S band frequency range. This signal is subsequently transmitted to S band antenna 214, which transmits the signal over communications link 116b to RAU 102.

As noted, links 118a and 118b between satellite 112 and gateway 114 can be in the C-band RF range, which is the range between 3 GHz and 7 GHz. However, in other embodiments, more specific ranges are possible. For example, in one embodiment up link 118a operates in the 5 GHz to 5.25 GHz frequency range, while down link 118b operates in the 6.875 GHz to 7.075 GHz frequency range. In still other embodiments, ranges outside of the C band frequencies can be used. For example, Ku band (ranging between approximately 10 GHz and approximately 15 Ghz frequencies) and Ka band (ranging in frequencies above approximately 15 GHz) are also possible.

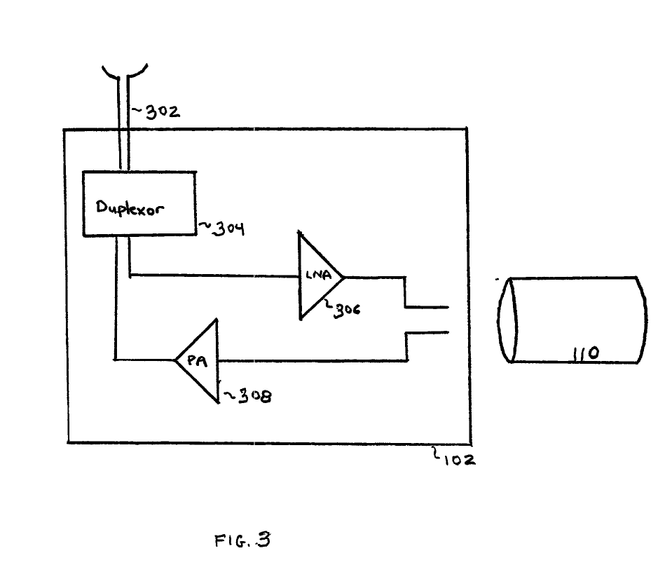

FIG. 3 is an exemplary block diagram of RAU 102. RAU 102 includes an antenna 302, a duplexer 304, a low noise amplifier (LNA) 306 and a power amplifier (PA) 308. In one embodiment, antenna 302 comprises stacked quadrifilar helical antennas which receive S band frequencies from satellite 112 and transmit L band frequencies to LEO satellite 112. However, those skilled in the art will recognize any appropriate antenna can be used depending upon the type of communications required.

The communications received and transmitted by antenna unit 302 are controlled by duplexer 304. Duplexer 304, which can comprise a plurality of bandpass radio frequency (RF) filters, separates the S band signals received by antenna 302 from the L band signals transmitted by antenna 302. In one embodiment, duplexer 304 uses one receive-side bandpass filter and one transmit-side bandpass filter to effect this separation. Duplexer 304 permits terminal unit 106 to have full duplex communications, so that both received and transmitted communications can be implemented simultaneously.

Duplexer 304 controls propagation of received S band frequencies from satellite 112, and transmits these frequencies to LNA 306. In turn, LNA 306 amplifies the received signal, and transmits the amplified signal to coaxial cable 110.

Similarly, duplexer 304 controls propagation of transmitted L band frequencies from RAU 102. These L band signals are transmitted by terminal unit 106 over coaxial cable 110 to PA 308. PA 308 amplifies the L band signals, and duplexer 304 controls propagation of the amplified L band signals by antenna 302.

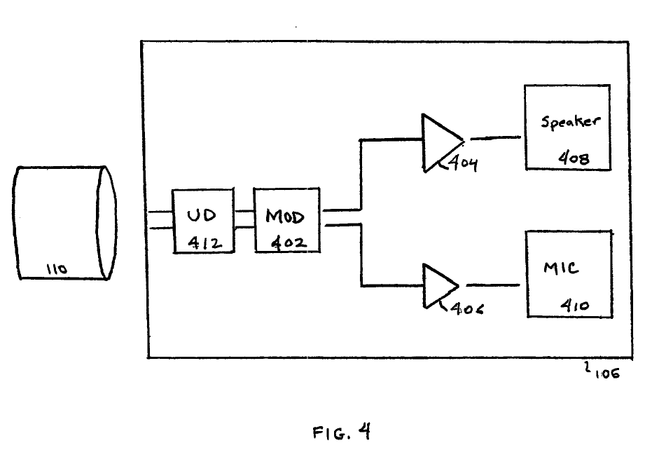

FIG. 4 is an exemplary block diagram of terminal unit 106. Terminal unit 106 includes a modem 402, operational amplifiers (op amps) 404 and 406, speaker 408, microphone 410, and up/down converter 412.

When an S band signal is received from LNA 306, over coaxial cable 110, the signal is down converted in frequency from the S band to an intermediate frequency (IF) signal by up/down converter 412. Up/down converter 412 includes one or more local oscillators, mixers, and band pass filters, as would be known to those skilled in the art. The received S band signal is mixed with an output from a local oscillator to reduce the frequency to an IF frequency range, and filtered. The resulting IF signal is transmitted to modem 402. Modem 402 has the function of modulating and demodulating the signal, to recapture the original audio signal. Modem 402 includes one or more local oscillators, mixers, and low pass filters. In modem 402, the IF signal is mixed with an oscillation output from a local oscillator and low pass filtered to remove the modulation from the signal (or in other words to demodulate the signal). The demodulated audio signal is amplified by op amp 404, and conveyed to a listener by speaker 408.

When a caller speaks into microphone 406, the signal is amplified by op amp 406, and transmitted to modem 402. The received signal is modulated by modem 402. In other words, the signal is mixed with the output of a local oscillator and filtered, in order to modulate the signal to an IF signal. The resulting IF signal is transmitted to up/down converter 412. Up/down converter 412 up-converts the frequency of the IF signal by mixing the signal with a higher frequency output of a local oscillator, and filtering the resulting signal, to yield an L band frequency signal. The L band signal is transmitted to RAU 102 over coaxial cable 110.

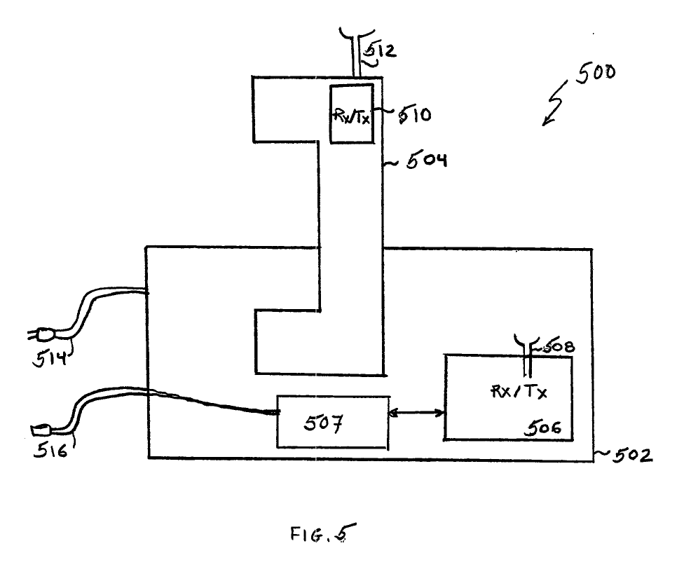

It should be noted that the functional blocks described with respect to FIGS. 4 and 5 are provided for explanatory purposes, rather than by way of limitation. For example, it is possible to combine the functions of up/down converter 412 and modem 402 into a single transceiver. This phenomenon is true for the entirety of the present invention. Further, terminal unit 106 includes a keypad and associated circuitry for entering numbers to be dialed when placing a call. Sometimes, in the case of a Princess® style phone, the keypad may be located in the handset.

Coaxial cable 110 carries the S and L band frequency signals between RAU 102 and terminal unit 106. Because coaxial cable 110 (or any other cable between RAU 102 and terminal unit 106) carries a signal in the RF frequencies, there is a severe problem of signal degradation over the length of the cable. Because losses are quite high, a very high-grade, thick cable is required. A typical cable may require a bend radius on the order of one meter. Such cables are quite expensive as well. One type of cable that can provide the required connection, at acceptable signal loss levels, is an LMR-100 cable. However, even a high-grade cable, like LMR-100, is effectively useful for lengths of only 25-40 feet. This can require that RAU 102 be placed on a roof of a building, with terminal unit 106 fixed in place, within 25-40 feet of RAU 102 and located to minimize bending of cable 110. This arrangement is expensive and inconvenient for the user.

The high losses attributed to the cable connection can be determined analytically. The received signal is limited by the ratio of the gain to the thermalized temperature of the system. There must be enough gain (or energy) for the receiver to effectively demodulate the signal. The transmitted signal is limited by the effective isotropic radiated power. There must be enough power for PA 308 to satisfy the requisite link margins for the system.

The present invention differs from the exemplary system shown in FIG. 1 in that the invention eliminates cable connection 110. As pointed out above, there are at least two significant disadvantages associated with known systems of the type shown in FIG. 1. First, the cable connection between RAU 102 and terminal 106 limits the placement of terminal 106 relative to RAU 102. Cable 110 can have a maximum length of only 25-40 feet to avoid signal degradation. Also, to limit signal loss, the maximum bend radius in a cable is limited to about one meter. Secondly, the cost of the cable adds significantly to the total cost of the fixed station system. Therefore, if one can eliminate cable 110, one achieves greater flexibility in placement of the terminal relative to the RAU and at a significantly reduced system cost. Present estimates are that fixed station acquisiton costs can be reduced by as much as fifty percent with the present invention.

To overcome the deficiencies associated with the coaxial cable 110, the present invention provides a wireless connection between RAU 102 and terminal unit 106. Preferably, the present invention uses cordless telephone frequencies and cordless telephone technology to implement this wireless connection. Clearly, other types of wireless connection can be used between RAU 102 and terminal unit 106. Cordless telephone technology has the advantage that it is inexpensive, so that the fixed station system cost is significantly reduced as compared to traditional cable connected systems. In addition, with cordless technology, there is substantially greater flexibility in locating the terminal unit relative to the RAU. Still further, no additional usage charges are incurred for calls placed or received with cordless phones. In addition, the frequencies required are already allocated in most jurisdictions or countries, decreasing the cost and delay for use or in implementation, over traditional approaches.

FIG. 5 illustrates an exemplary standard cordless telephone 500. Cordless telephone 500 includes a base unit 502, a handset 504, and a power cord 514. Base unit 502 includes a transceiver 506, which functions as an RF receiver and transmitter, a converter 507 to convert the RF signals to standard analog telephone line signals, a standard RJ11 telephone interface 516, and an antenna 508. Similarly, handset 504 includes a transceiver 510 and an antenna 512. Base unit 502 and handset 504 communicate by way of transceivers 506, 510, and antennas 508, 512. Cordless telephone 500 also includes internal circuitry for converting signals received by transceiver 506 into an RJ11 standard, and vice versa, for communication between the user and a calling or called party. Base unit 502 also includes internal circuitry (not shown) for charging handset 504 with electrical power received from power cord 514.

In one embodiment, the present invention modifies the traditional cordless telephone by relocating the signal processing circuitry normally contained in base unit 502 to RAU 102. The functional elements found in handset 504 are located in terminal unit 106, in order to implement a wireless connection between RAU 102 and terminal unit 106. In one embodiment, the functional units found in handset 504 are contained in a desk or wall mounted unit to which a standard wired telephone handset is connected. In an alternate embodiment, terminal unit 106 may comprise a battery operated telephone handset, similar to handset 504, and a base unit containing only a power supply and battery charger for the handset.

In most countries, base unit 502 and handset 504 communicate in frequencies defined by the CT-1 standard as between 30 MHz and 50 MHz. In the United States, South Korea and Latin America, base unit 502 functions between 43.72 MHz and 46.97 MHz, while handset 504 functions between 48.76 MHz and 49.97 MHz. But these values differ for different countries. In France, the respective values are 26 MHz and 41 MHz. In Australia, the respective values are 30 MHz and 39 MHz. In the Netherlands and Spain, the respective values are 31 MHz and 40 MHz. In China, the respective values are 48 MHz and 74 MHz. In the United Kingdom, the respective values are 2 MHz and 48 MHz. In Sweden, the respective values are both 900 MHz. Accordingly, the frequencies used must be adapted depending upon the country, as would be readily known to one skilled in that art.

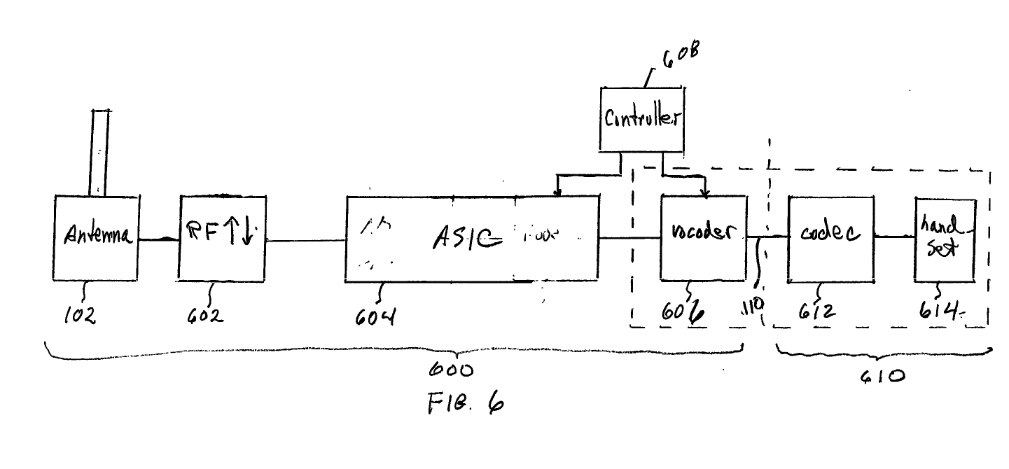

FIG. 6 illustrates an exemplary known fixed phone system employing a cable connection between an RAU 600 and a telephone terminal set 610 in a digital communications environment. As shown, the RAU mounted on a pole or tower comprises antenna 102, and an RF up/down converter 602. On the receive side, RF converter 602 converts S-band signals received at a frequency of about 2.492 GHz to an intermediate frequency of about 244.88 MHz for subsequent transmission over the cable connection and further processing ultimately to be perceived as audio signals at the telephone terminal handset. On the transmit side, RF converter converts signals being transmitted from the handset and preprocessed to an IF of 244.88 MHz to L-band signals at about 1.685 GHz that are fed to antenna 102 and sent out to satellite 112. An Application Specific Integrated Circuit (ASIC) 604 converts and demodulates the down-covnverted received signals, such as CDMA type spread spectrum communication signals, for input to a vocoder 606 and modulates and converts signals from vocoder 606 to be upconverted by converter 602 and then transmitted by antenna 102. A controller 608 provides the necessary control functions for ASIC 604 and vocoder 606. The components of RAU 600 are connected to terminal unit 610 by cable 110. Terminal unit 610 contains a coder/decoder (codec) 612 and a telephone handset 614 containing the microphone and speaker.

The components of the wired fixed phone system described above are well known to persons skilled in the art of satellite communications.

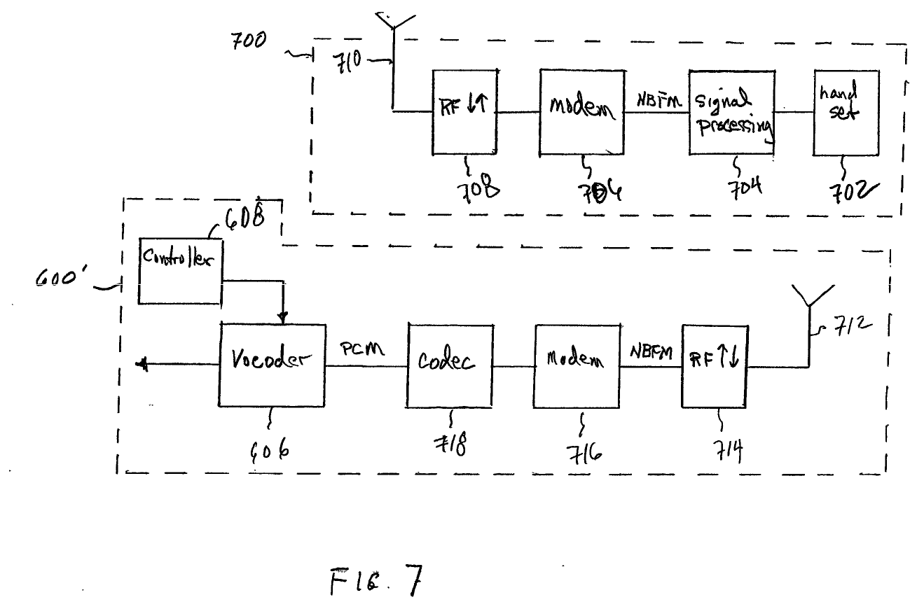

FIG. 7 illustrates a fixed phone system according to the present invention. The invention differs from known systems of the type illustrated in FIG. 6 by inserting a wireless connection between RAU 600 and terminal unit 610. The preferred embodiment uses a wireless CT-1 frequency connection. As those skilled in the art will recognize, it is possible to modify RAU 600 to provide many other forms of wireless connection, including cordless telephone frequencies outside the CT-1 frequency range, or another type of wireless connection known to those skilled in the art.

Terminal unit 700 includes a handset 702 which contains a standard telephone microphone and speaker. The handset may be connected to a signal processing component 704, such as a codec, which converts analog audio signals to Pulse Code Modulated (PCM) signals if the handset is a digital phone or to Narrow Band FM (NBFM) signals if the handset is an analog phone. The signal processor 704 is connected to a modem 706 which modulates the transmitted signal and demodulates the received signal in a known manner. Modem 706 is connected to an RF up/down converter 708 which converts the transmitted signal up to CT-1 frequencies and the received signal down from CT-1 frequencies. Converter 708 is connected to a standard antenna 710 of the type found on cordless phones. Typically, antenna 710 is a vertically polarized dipole.

For this invention, modified RAU 600′ as shown in FIG. 7 adds a dipole antenna 712, an RF up/down converter 714, a modem 716, and a codec 718 to process the transmitted and received signals into and out of vocoder 606, appropriately. Converter 714, modem 716 and codec 718 are components that are typically found in the base unit of a standard cordless phone. In a standard cordless digital phone, the front end of codec 718 is connected to signal processing components that are connected to the wireline telephone system. However, such components are omitted in this invention, since codec 718 is connected to vocoder 606 to process PCM signals into and out of vocoder 606.

The present invention provides significant advantages over known or previously contemplated fixed satellite phone systems. Cordless phones using standard technology currently available and incorporated into commercial cordless phones have a transmit/receive range on the order of up to a thousand meters or more. By eliminating the expensive and physically limiting cable connection between the RAU and the terminal unit, and by incorporating the transmit/receive components normally found in the base unit of a cordless phone, the present invention achieves at least two significant advantages. It is able to provide a fixed satellite phone setup that is inexpensive to purchase for remote locations. Also, the terminal unit can be located more flexibly and independent of the specific RAU. This means that the RAU can be mounted in a location that provides clear lines of sight to satellites, while the terminal unit can be placed in a location that is more convenient for the most users in that remote area.

In addition, each of the units can be moved independently as desired or as required by changing circumstances. For example, alternate locations within a dwelling may be more convenient, or another structure more suitable. Individuals in charge of the terminal unit might move locations. In case of damage or loss of structures due to various causes, it is also convenient to be able to move the terminal without rewiring. Likewise for the RAU, when the support is damaged or moved, or where interfering or obstructive structures come into being requiring alternative placement. In each of these, and other known situations, cost is reduced and flexibility gained, using the present invention. This may also be true for service or replacement where a temporary RAU can be placed nearby to accommodate communications while the primary RAU is being replaced or serviced. This can be accomplished without rerouting wires or creating an unaesthetic or unsafe connection.

While various embodiments of the present invention have been described above, it should be understood that they have been presented by way of example only, and not limitation. Thus, the breadth and scope of the present invention should not be limited by the above-described exemplary embodiments, but should be defined only in accordance with the following claims and their equivalents.

What I claim as my invention is:

1. A fixed phone arrangement for a wireless communications system, comprising:
a radio antenna unit that communicates with a central station over a first wireless link; and
a terminal unit that communicates with said radio antenna unit over a second wireless link.

2. The fixed phone arrangement according to claim 1, wherein said radio antenna unit comprises:
means for transmitting signals to and receiving signals from one or more satellites over said first wireless link;
means for processing and converting received signals from satellite transmission frequencies to preselected lower frequencies; and
local transceiver means for transmitting said lower frequency signals to said terminal unit over said second wireless link.

3. The fixed phone arrangement according to claim 2, wherein said lower frequencies comprise CT-1 frequencies.

4. The fixed phone arrangement of claim 1, wherein said terminal unit comprises means for transmitting CT-1 frequency signals to and receiving signals from said local transceiver means.
